(19) United States
(12) Patent Application Publication
(10) Pub. No.: US 2026/0312318 A1
(43) Pub. Date: Oct. 8, 2026

(54) SPLIT MODULE FOR MODULAR CONNECTOR ASSEMBLY

(71) Applicant: Aptiv Technologies AG, Schaffhausen (CH)

(72) Inventors: Andreas URBANIAK, Münster (DE); Markus GAERTNER, Wuppertal (DE); Uvaraj GANESAN, Tamil Nadu (IN); Rajan KUMARESH, Tamil Nadu (IN); Vijay Babu MOORTHY, Tamil Nadu (IN)

(21) Appl. No.: 19/545,690

(22) Filed: Feb. 20, 2026

(30) Foreign Application Priority Data
Apr. 4, 2025 (EP) 25168567.3

(51) Int. Cl. H01R 13/04; H01R 13/428; H01R 43/16

(52) U.S. Cl. CPC H01R 13/04; H01R 13/428; H01R 43/16

(57) ABSTRACT

A modular pin block is provided for mounting into a housing of a modular connector. The modular pin block includes a pin block support having a first connection surface and a second connection surface opposite the first connection surface, and at least one pin extending through the pin block support such that the at least one pin protrudes from the first connection surface and from the second connection surface. The pin block support may include latching structure configured to retain the modular pin block within a seat of the connector housing, and orientation features configured to define a mounting orientation of the modular pin block relative to the connector housing. Connector housings including one or more such modular pin blocks, and methods of producing modular pin blocks, are also disclosed.

### CROSS-REFERENCE TO RELATED APPLICATION

This application claims the benefit of and priority to European Application No. 25168567.3 filed with the European Patent Office on Apr. 4, 2025, the contents of which are incorporated by reference herein.

### TECHNICAL FIELD

The present disclosure relates to a modular pin block for mounting into a housing of a modular connector. Specifically, the present disclosure relates to a pin block support with at least one pin extending through it, protruding from both a first and a second connection surface.

### BACKGROUND

In the field of modular connectors, it is common to utilize pin blocks for establishing electrical connections within several types of electronic and mechanical systems. Known systems typically involve pin blocks that are integrated into connector housings, allowing for the transmission of electrical signals between different components. These pin blocks are crucial for ensuring reliable connectivity, especially in environments where connectors are frequently engaged and disengaged. Despite their widespread use, traditional pin blocks often face challenges related to ease of installation, secure attachment, and adaptability to different configurations.

Existing approaches in modular connector systems frequently rely on pin blocks that are either permanently fixed within the connector housing or require complex assembly processes. This can lead to increased manufacturing costs and difficulties in maintenance or replacement of individual components. Furthermore, known systems may lack flexibility in accommodating various pin sizes and configurations, which can limit their applicability across different use cases. The secure attachment of pin blocks within the housing is another area of concern, as inadequate latching mechanisms can result in poor connectivity. Additionally, ensuring proper alignment and orientation of pin blocks during installation is critical to prevent misalignment and ensure optimal performance.

Despite the substantial advances in the field of modular connectors, there remains a need for improved solutions that address these challenges. Specifically, there is a demand for pin blocks that can be easily and securely mounted into connector housings, while offering flexibility in terms of pin arrangements and sizes. Enhanced latching mechanisms that provide reliable attachment without compromising ease of installation are also desirable. Moreover, solutions that ensure proper alignment and orientation of pin blocks during installation would significantly enhance the reliability and performance of modular connector systems. It is therefore a technical problem underlying the present invention to provide a modular pin block system that at least partially overcomes the disadvantages of known systems.

### SUMMARY

The present disclosure relates to modular connectors and, more particularly, to modular pin blocks for mounting into a housing of a modular connector.

In one aspect, a modular pin block is provided for mounting into a housing of a modular connector. The modular pin block includes a pin block support having a first connection surface and a second connection surface opposite the first connection surface, and at least one pin extending through the pin block support such that the at least one pin protrudes from the first connection surface and from the second connection surface.

In some embodiments, the pin block support includes latching structure configured to allow insertion of the modular pin block into a seat of the connector housing and to retain the modular pin block within the seat. The latching structure may include one or more resilient arms, resilient bars, indentations, or combinations thereof. In some embodiments, the pin block support includes side edges extending between the first and second connection surfaces, and the latching structure includes a flexible bar resiliently attached to at least a portion of at least one side edge and extending substantially perpendicular to a longitudinal extension of the at least one pin.

In some embodiments, the pin block support includes at least one distance pad configured to reduce or eliminate clearance between the pin block support and the seat of the connector housing in a mounted condition. The pin block support may further include a skirt configured to limit insertion of the modular pin block into the seat and to retain the modular pin block within the connector housing.

In some embodiments, an outer shape of at least one of the first connection surface or the second connection surface defines a mounting orientation of the modular pin block relative to the connector housing, such that the modular pin block is insertable into the seat only in a predetermined orientation.

In some embodiments, the pin block support is configured to accommodate a plurality of pins arranged in one or more rows. The pins may be of a single size or of different sizes, and the pin block support may be populated with all pin positions filled or with fewer pins than available pin positions.

In another aspect, a connector housing is provided. The connector housing includes circumferential side walls and a connector interface having one or more seats, each seat being configured to receive a modular pin block as disclosed herein. In some embodiments, the modular pin block and the seat are complementarily shaped. In some embodiments, the modular pin block is additionally secured to the connector housing by laser welding.

In a further aspect, a method of producing a modular pin block is provided. The method includes either stitching at least one pin through a pin block support having pin holes arranged according to a desired pattern or arranging at least one pin according to a desired pattern and molding the pin block support around the at least one pin.

### BRIEF DESCRIPTION OF THE DRAWINGS

Other features, details, and advantages of the disclosure will become more apparent from the detailed illustrative description given hereafter with respect to the drawings in which:

FIG. 1 shows an isometric view of a modular pin block with pins extending through a pin block support according to some embodiments.

FIG. 2A shows an end view of a connector housing with empty seats for receiving modular pin blocks according to some embodiments.

FIG. 2B shows an end view of the connector housing of FIG. 2A with various modular pin blocks inserted into the seats according to some embodiments.

FIG. 3 shows an end view of a modular pin block with pins extending through the pin block support according to some embodiments.

FIG. 4 illustrates a cross-sectional side view of the pin block, highlighting the pins, connection surfaces, and the latching structure according to some embodiments.

FIG. 5 depicts a cross-sectional isometric view of a connector housing with a pin block mounted within according to some embodiments

FIG. 6 shows an exploded view of a pin block support and a pin prior to stitching the pin to the pin block support according to some embodiments.

FIG. 7A depicts an isometric view of a modular pin block with pins extending through each pin hole of the pin block support according to some embodiments.

FIG. 7B depicts an isometric view of a modular pin block with fewer pins through the pin block support than pin holes on the pin block support according to some embodiments.

FIG. 8 shows an isometric view of multiple pins arranged in a pattern prior to molding the pin block support according to some embodiments.

FIG. 9A shows an isometric view of a modular pin block after molding the pin block support onto the pins arranged in the pattern shown in FIG. 8 according to some embodiments.

FIG. 9B shows an isometric view of a modular pin block after molding the pin block support onto pins arranged on a different pattern than shown in FIG. 8 according to some embodiments.

FIG. 10A shows an isometric view of a half-module pin block according to some embodiments.

FIG. 10B shows an isometric view of a half-module pin block according to some embodiments.

FIG. 11 shows an isometric view of laser welding points on the connector housing and laser welding on a pin block according to some embodiments.

### DETAILED DESCRIPTION

In the following, preferred embodiments of the present disclosure are described in detail with respect to the figures.

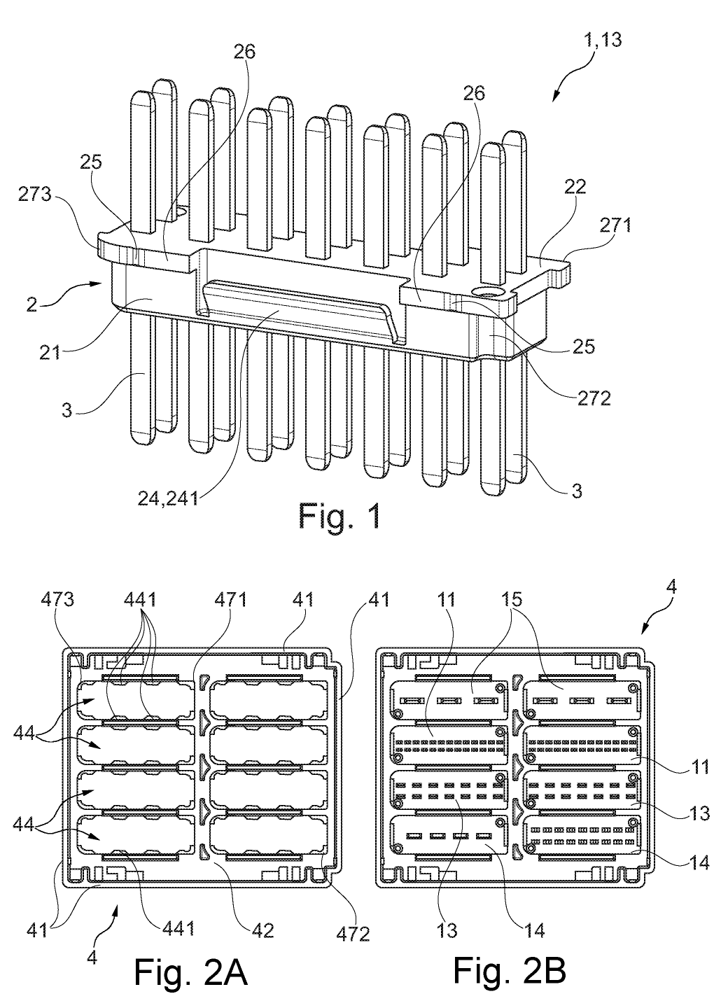

FIG. 1 shows a modular pin block 1 designed for mounting into a housing 4 of a modular connector (not shown in FIG. 1). The pin block 1 includes a pin block support 2 with a general rectangular shape and featuring side edges 21 that extend between a first connection surface 22 and a second connection surface 23 (not visible in FIG. 1) opposite the first connection surface 22. In other words, the pin block support 2 includes side edges 21 that run between the first and second connection surfaces. In the shown pin block 1, in the following also labeled “third modular pin block 13 of the type 1.2”, two rows of nine pins 3 of the size 1.2 extend through the pin block support 2, protruding from both the first connection surface 22 and the second connection surface 23. The latching structure 24, which may include resilient arms or resilient bars 241, are designed to facilitate the insertion of the pin block 1 into a seat 44 of the connector housing 4 and to latch it securely onto the seat 44. Additionally, the pin block support 2 is equipped with distance pads 25 on the side edges 21, intended to eliminate any gap between the pin block support 2 and the seat 44 when mounted. The support 2 also features a skirt 26 near the vertex of the side edges 21, designed to hold the pin block 1 within the seat 44 by impeding movement beyond the seat in the direction of insertion. In the shown example embodiment, the outer shape of the first connection surface 22 and the outer shape of the second connection surface 23 both define the mounting orientation, ensuring that the pin block 1 can only be inserted in one predefined direction into the housing 4. Specifically, on a shorter side, the first connection surface has first orientation features 271 in the shape of angled corners that are continued on the skirt, and the second connection surface has recessed corners as second orientation feature 272 that are continued on the side edges. On the opposite side the first connection surface has third orientation features 273 in the shape of rounded corners that are continued on the skirt.

FIG. 2A and 2B illustrate the connector housing 4 in two views. In FIG. 2A, the housing 4 is shown in a top view as substantially box-shaped with circumferential side walls 41 that provide protection to the pins 3 of the pin block 1. The connector interface 42, which is substantially perpendicular to and received within the side walls 41, includes multiple (8) seats 44. Each seat 44 is designed to receive a pin block 1. The seats 44 feature a pair of indentations 441 on each long side of the seat that are complementary to the resilient bars 241 of the pin block support 2, ensuring secure latching. The housing 4 also includes orientation details 471, 472, and 473 that are complementary to the orientation features 271, 272, 273 of the pin block 1, ensuring proper alignment and insertion.

In FIG. 2B, the housing 4 is shown with multiple (8) pin blocks 11, 12, 13, 14, and 15 mounted within the seats 44. Each pin block is secured within the housing 4, with the outer shape of the pin block support of each pin block being essentially identical. The pin blocks include pins of varied sizes, demonstrating the modularity and flexibility of the design. Specifically, in the shown example, two first modular pin blocks 11 are shown, having two rows of 13 pins 3 of size 0.50, one second modular pin block 12, having two rows of 9 pins 3 of size 0.63, two third modular pin blocks 13, having two rows of 7 pins 3 of size 1.2, one fourth modular pin block 14, having one row of 4 pins 3 of size 2.8, and finally two fifth modular pin blocks 15, having one row of 3 pins 3 of size 4.8. In particular the use of modular pin blocks obviates the risk of damaging pins 3, which is particularly applicable to the first and second modular pin blocks 11, 12 as these have especially thin and fragile pins 3.

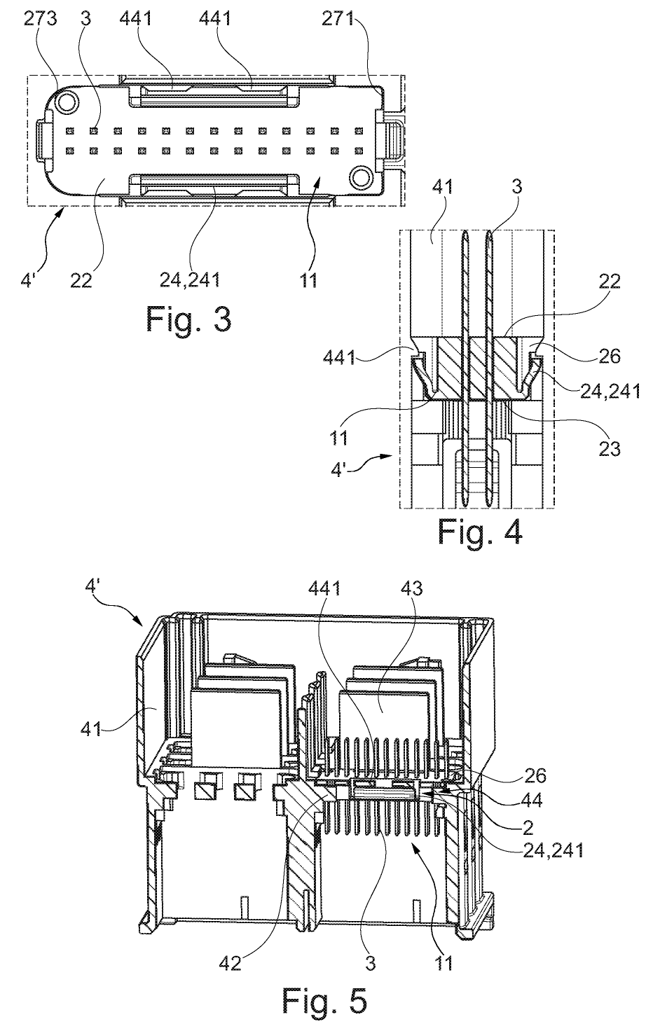

FIG. 3 illustrates a top view of a modular pin block 11, which is mounted into a housing 4’ of a modular connector. The pin block 11 includes a pin block support 2 with a first connection surface 22. The pin block support 2 is shown to have multiple pins 3 extending through it, arranged in a grid pattern. These pins 3 protrude from both the first connection surface 22 and the opposite second connection surface 23, as seen in FIG. 4. The pin block support 2 includes a latching structure 24, which are resilient bars 241 designed to secure the pin block support 2 within the seat 44 of the connector housing 4’. Each resilient bar 241 cooperates with a pair of indentations 441 on the inner edge of the seat. The pin block 11 also features orientation features 271 and 273, which only allow a polarized insertion of the pin block support 2 into the seat 44.

FIG. 4 provides a cross-sectional view of the modular pin block 11 being arranged in the housing a’, showing the pins 3 extending through the pin block support 2 from the first connection surface 22 to the second connection surface 23. The latching structure 24 are depicted as resilient bars 241 that engage with the indentations 441 of the connector housing 4’ to secure the pin block 11 in place. Additionally, the figure shows a skirt 26 on the pin block support 2, which is designed to hold the pin block within the seat of the connector housing by impeding movement beyond the seat in the direction of insertion. In the shown picture, part of the skirt is not visible because it is hidden behind the indentations. The height of the circumferential side walls 41 of the connector housing 4’ is at least equal to the length of the pins 3, which allows the connector housing 4’ to protect the pins 3 from damage.

FIG. 5 illustrates the connector housing 4’, which is substantially box-shaped and includes circumferential side walls 41. The housing 4’ is designed to accommodate multiple modular pin blocks. The connector interface 42 is shown to be substantially perpendicular to and received within the side walls 41. The pin block 11 is received in a seat 44 of the connector interface 42. The figure highlights the complementary shaping of the pin block 11 and the seat 44, ensuring proper alignment and securement. The housing 4’ provides protection to the pins 3 of the pin block 11, with the side walls 41 serving as a barrier against external elements. In the shown picture the circumferential side walls are substantially higher than the protruding pins 3. As depicted, the connector housing 4’ can include shielding walls 43 between the seats 44 and thus between the modular pin blocks within the circumferential side walls 41 to shield the different pin blocks and avoid interferences. The figure also shows the presence of indentations 441 in the seat 44, which are complementary to the latching structure 24 of the pin block 11, ensuring a secure fit. The skirt 26 is visible, protruding outwardly from the pin block support 2, further securing the pin block 11 within the housing 4’. The connector interface 42 is designed to facilitate the connection of the pin block 11 to external components, with the pins 3 extending through the interface for electrical connectivity. The overall design ensures that the pin block 11 is held securely within the housing 4’, with the latching structure 24 and skirt 26 working in conjunction to prevent movement and maintain alignment.

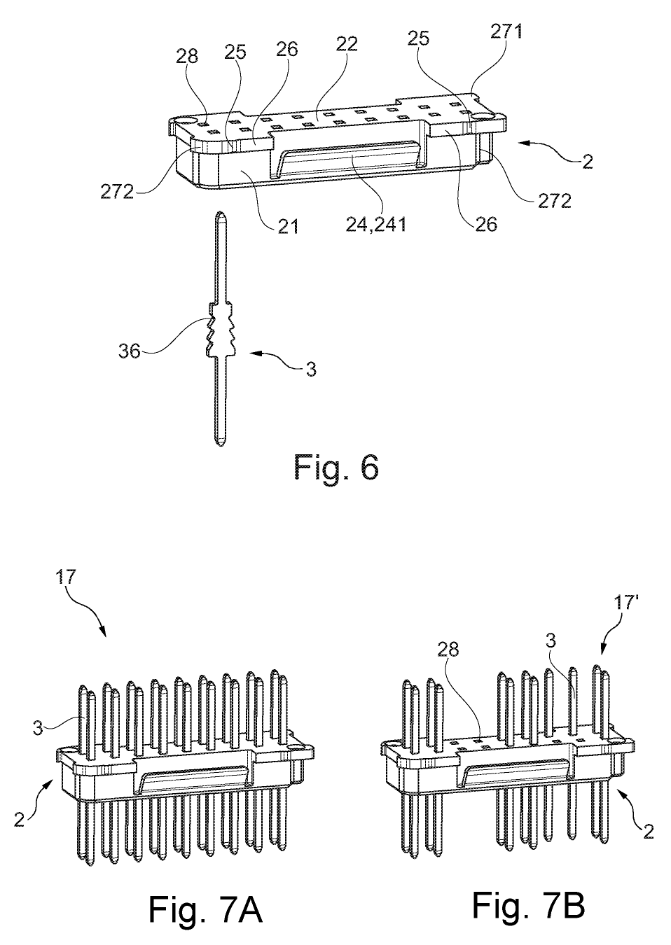

FIG. 6 illustrates a pin block support 2 and a pin 3 prior to stitching the pin 3 to the pin block support 2. Further to the features already described in connection with the previous figures, the pin block support 2 includes pin holes 28, which are designed to accommodate the pins 3 according to a desired pattern. The pin 3 is shown with retention barbs 36 that interact with the pin block support 2 to secure the pin 3 in place.

FIG. 7A and 7B illustrate two different possibilities of accommodating pins within the pin block support 2. FIG. 7A depicts a first embodiment of a modular pin block 17 with pins 3 extending through each pin hole 28 of the pin block support 2. FIG. 7B depicts a second embodiment of a modular pin block 17’ with fewer pins through the pin block support than pin holes on the pin block support. These figures illustrate the modular nature of the pin block, allowing for various configurations of pins 3 to be arranged on the pin block support 2, depending on the specific requirements of the connector housing.

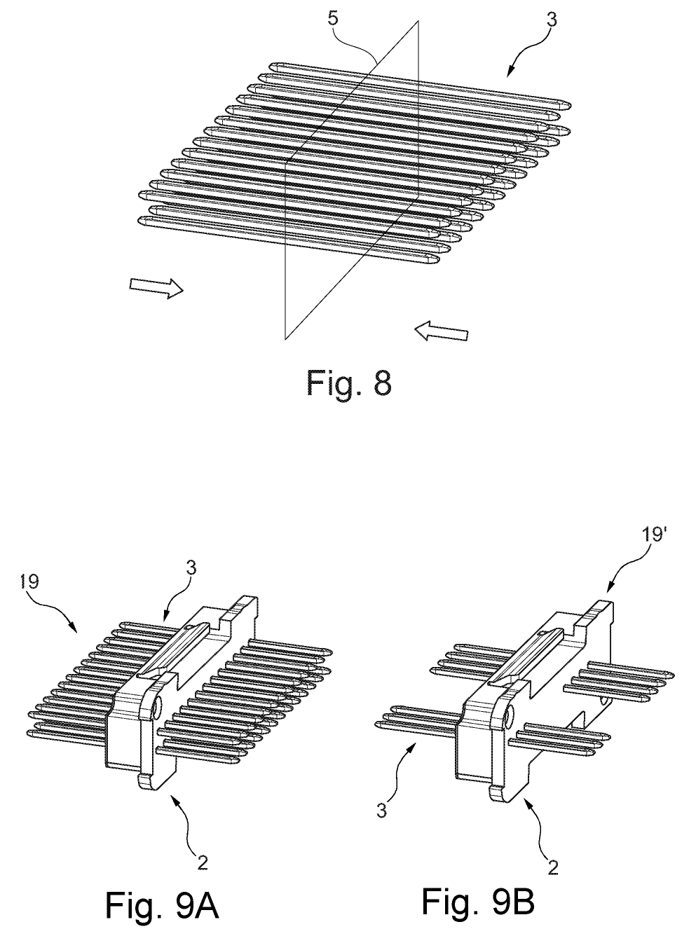

FIG. 8 illustrates multiple pins arranged in a pattern prior to molding the pin block support. The pins 3 are aligned in a parallel configuration, and extend through a molding plane 5, which is the plane in which the pin block support 2 is molded after the pins are arranged according to the desired pattern. The arrows indicate the direction of the tools molding the pin block support.

Two embodiments of the modular pin blocks 19, 19’ obtained after molding the pin block support 2 onto the pins 3 are shown in FIGS. 9A and 9B. In the embodiment shown in FIG. 9A, the modular pin block 19 includes as many pins 3 as can be arranged on the pin block support. In contrast, in the embodiment of the modular pin block 19’ shown in FIG. 9B, the pin block support 2 has been molded onto pins 3 arranged in a different pattern than shown in FIG. 8, and in particular onto fewer pins 3 than can be accommodated in the pin block support 2.

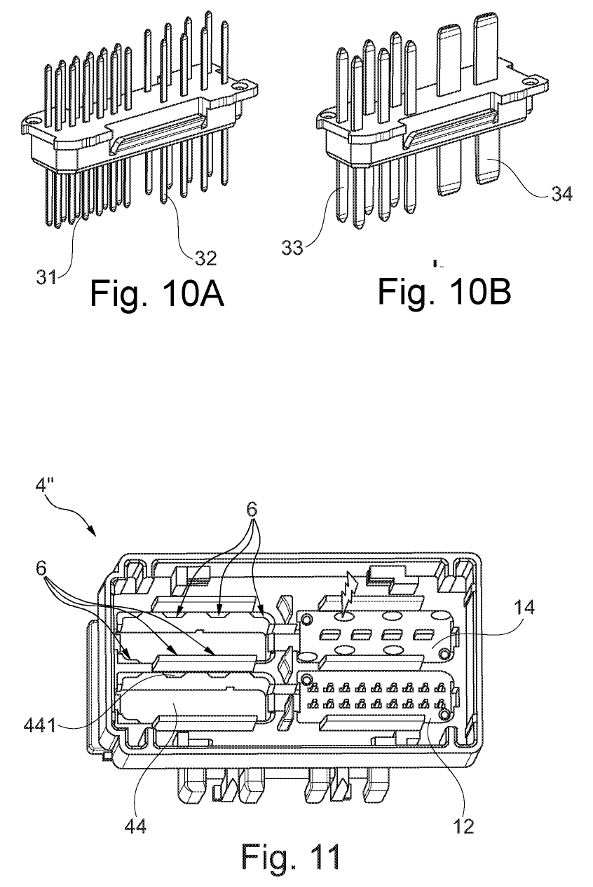

FIGS. 10A and 10B exemplify split modular pin blocks or half-module pin blocks, with a combination of pins of assorted sizes. FIG. 10A shows a combination of pins 31 and pins 32 within one pin block, whereas FIG. 10B shows a combination of pins 33 and pins 34 within one pin block. Splitting modular pin blocks further increases the adaptability of the pin blocks to specific needs and allows more possibilities of modularity. In particular, half-module pin blocks allows saving space on the connector housing.

FIG. 11 indicates the location of laser welding points 6 on the connector housing 4’’. In this example, the laser welding points are on the indentations 441 and on two diagonal corners of each seat 44. On the bottom right seat, a second modular pin block is shown and on the top right seat of the connector housing a fourth modular pin block 14 is shown. On the fourth modular pin block 14 the laser welding is indicated by oval spots. Welding spots make sure that the pin block does not detach from the connector housing in repeated mating and unmating operations.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE SIGNS

1 modular pin block

11 first modular pin block for pins of the type 0.50

12 second modular pin block for pins of the type 0.63

13 third modular pin block for pins of the type 1.2

14 fourth modular pin block for pins of the type 2.8

15 fifth modular pin block for pins of the type 4.8

17, 17’ modular pin block

19, 19’ modular pin block

2 pin block support

21 side edge[s]

22 first connection surface

23 second connection surface

24 latching structure

241 resilient bar[s]

25 distance pad[s]

26 skirt

271 first orientation feature

272 second orientation feature

273 third orientation feature

28 pin hole[s]

29 pick-up part[s]

3 pin[s]

31 pins of the type 0.50

32 pins of the type 0.63

33 pins of the type 1.2

34 pins of the type 2.8

35 pins of the type 4.8

36 retention barb[s]

4, 4’, 4’’ connector housing

41 circumferential side wall[s]

42 connector interface

43 shielding wall[s]

44 seat[s]

441 indentation[s]

471 first orientation detail

472 second orientation detail

473 third orientation detail

5 molding plane

6 laser welding point[s]

1. A modular pin block for mounting into a housing of a modular connector, the modular pin block comprising
a pin block support having a first connection surface and a second connection surface opposite the first connection surface, and
at least one pin extending through the pin block support such that it protrudes from the first connection surface and from the second connection surface.

2. The modular pin block according to claim 1, wherein the pin block support comprises a latching structure designed to allow insertion of the pin block into a seat of the connector housing and to latch the pin block onto the seat of the connector housing.

3. The modular pin block according to claim 2, wherein the latching structure is one or more of resilient arms, bars, or indentations.

4. The modular pin block according to claim 2, wherein the pin block support comprises a side edge between the first connection surface and the second connection surface and wherein the latching structure comprises a long flexible bar resiliently attached to at least half of a length of at least one side edge and extending substantially perpendicular to a longitudinal extension of the at least one pin.

5. The modular pin block according to claim 4, wherein the pin block support comprises at least one distance pad designed to eliminate any gap between the pin block support and a seat of the connector housing in a mounted condition.

6. The modular pin block according to claim 5, wherein the pin block support includes a skirt designed to hold the pin block within the seat of the connector housing.

7. The modular pin block according to claim 6, wherein the skirt protrudes outwardly from the first connection surface or the second connection surface in a direction perpendicular to the longitudinal extension of the at least one pin.

8. The modular pin block according to claim 1, wherein a mounting orientation is defined by an outer shape of the first connection surface or an outer shape of the second connection surface.

9. The modular pin block according to claim 1, configured to accommodate a plurality of pins selected from the list consisting of:
two rows of 13 pins of size 0.50,
two rows of 9 pins of size 0.63,
two rows of 7 pins of size 1.2,
one row of 4 pins of size 2.8,
one row of 3 pins of size 4.8,
a defined quantity of pins of the same size, and
a combination of pins of varied sizes can be accommodated on the pin block support, wherein as many pins are arranged on the pin block support as can be accommodated.

10. The modular pin block according to claim 1, configured to accommodate a plurality of pins selected from the list consisting of:
two rows of 13 pins of size 0.50,
two rows of 9 pins of size 0.63,
two rows of 7 pins of size 1.2,
one row of 4 pins of size 2.8,
one row of 3 pins of size 4.8,
a defined quantity of pins of the same size, and
a combination of pins of varied sizes can be accommodated on the pin block support, wherein fewer pins are arranged on the pin block support than can be accommodated.

11. A connector housing comprising at least one modular pin block according to claim 1, the housing being substantially box-shaped and comprising circumferential side walls (41) and a connector interface with one or more seats, wherein the connector interface is substantially perpendicular to and received within the side walls, and wherein the at least one modular pin block is received in the at least one seat.

12. The connector housing according to the claim 11, wherein the at least one pin block and the at least one seat are complementary shaped.

13. The connector housing according to the claim 11, wherein the at least one pin block is secured by laser welding to the connector interface.

14. The connector housing according to the claim 11, wherein the pin block support comprises a latching structure designed to allow insertion of the pin block into a seat of the connector housing and to latch the pin block onto the seat of the connector housing, wherein the latching structure comprises one or more resilient arms or bars or one or more indentations, and wherein the seats comprise indentations complementary to the latching structure.

15. The connector housing according to the claim 11, comprising at least a first and a second pin block, wherein an outer shape of the pin block support of both pin blocks is identical and wherein the first pin block includes pins of a different pin size than the second pin block.

16. A method of producing a pin block having a pin block support having a first connection surface and a second connection surface opposite the first connection surface and at least one pin extending through the pin block support such that it protrudes from the first connection surface and from the second connection surface, the method comprising:
providing a pin block support with pin holes according to a desired pattern; and
stitching the at least one pin through the pin block support.

17. The connector housing according to the claim 16, further comprising:
arranging the at least one pin according to a desired pattern; and
molding the pin block support around the at least one pin.
